(19) United States
(12) Patent Application Publication
(10) Pub. No.: US 2002/0019743 A1
(43) Pub. Date: Feb. 14, 2002

(54) Content distribution system and content distribution method

(76) Inventor: Shunsuke Nakamura, Hamamatsu-shi (JP)

Correspondence Address: David L. Fehrman, Morrison & Foerster LLP, 35th Floor, 555 W. 5th Street, Los Angeles, CA, 90013, US

(21) Appl. No.: 09/916,495

(22) Filed: Jul. 26, 2001

(30) Foreign Application Priority Data
Jul. 28, 2000 (JP) 2000-229737
Jul. 28, 2000 (JP) 2000-229746

(51) Int. Cl. G06F 17/60; H04K 1/00; H04L 9/00

(52) U.S. Cl. 705/1; 705/52

(57) ABSTRACT

A content distribution system includes a distribution server, a creator terminal, and a client terminal. In response to a request from the creator terminal, the distribution server provides an authoring tool to the creator terminal. The creator terminal provides the distribution server with a content item (e.g., an incoming-call melody) created by use of the authoring tool. The distribution server stores the content item. In response to a request from the client terminal, the distribution server supplies the stored content item to the client terminal. At this time, the distribution server charges a fee to a registered user of the client terminal, and kicks a portion of the charged fee back to a registered user of the creator terminal who has provided the content item.

### BACKGROUND OF THE INVENTION

1. Field of the Invention

The present invention relates to a content distribution system which includes a creator terminal, a distribution server and a client terminal, which are capable of communicating with one another, and which is configured to accumulate within the distribution server a content item supplied from the creator terminal and to distribute the content item to the client terminal in response to a request from the client terminal. The present invention also relates to a content distribution method applicable to the distribution system, a distribution server having a content distribution function, a content distribution method applicable to the distribution server and a computer readable recording medium on which is recorded a distribution program for realizing the distribution method.

2. Description of the Related Art

Conventionally, there has been practiced a scheme in which an incoming-call melody of a cellular phone (a sound generated from the cellular phone as a ringing tone upon reception of an incoming call) is accumulated in a distribution server as a content item, and the thus-accumulated incoming-call melody is supplied to a cellular phone (client terminal) in response to a request therefrom.

However, in the case of the conventional scheme for distributing incoming-call melodies, only famous music pieces are accumulated within the distribution server, on the basis of contracts between specific companies. Therefore, an individual's desire to provide other persons with an incoming-call melody created by him/herself cannot be satisfied. Further, converting data of an incoming-call melody to data having formats suitable for various types of cellular phones has been difficult, because their hardware and software functions are restricted in various aspects. Moreover, it has been impossible for each individual to choose a favorite one from among a large number of music pieces selected from a wide range and use it as an incoming-call melody; e.g., to use, as an incoming-call melody, a music piece created by a friend or another member of a group.

### SUMMARY OF THE INVENTION

In view of the foregoing, an object of the present invention is to provide a content distribution system which enables any person to accumulate a content item created for other persons into a distribution server through a simple operation, and enables the other persons to select and obtain a desired content item from among a large number of content items through a simple operation.

Another object of the present invention is to provide a content distribution method applicable to the distribution system, a distribution server having a content distribution function, a content distribution method applicable to the distribution server, and a computer readable recording medium on which is recorded a distribution program for realizing the distribution method.

In order to achieve the above objects, according to a first aspect of the present invention, when a content item supplied from a creator terminal and stored in a distribution server is supplied to a client terminal in response to a request therefrom, a fee is charged to a user of the client terminal, and a portion of the charged fee is kicked back to a registered user of the creator terminal who has supplied the content item. The client terminal may be a phone, and the content item may be a piece of music used on the phone.

When many creators (users of creator terminals) supply content items from their creator terminals, the distribution server stores a large number of content items created by the creators. Therefore, a client (a user of a client terminal) can use a desired content item selected from among the large number of content items. Also, each creator's desire that other persons be able to use a content item created by him/herself can be satisfied. Moreover, when a certain content item is used by a client, a portion of a fee charged to the client is kicked back to the creator who has provided the content item, thereby encouraging the creator to provide content items enthusiastically. Thus, a larger number of content items are accumulated within the distribution server.

According to a second aspect of the present invention, in response to a request from the creator terminal, the distribution server provides the creator terminal with an authoring tool for converting into a predetermined format a content item supplied from the creator terminal to the distribution server. By virtue of this feature, when the client terminal is a terminal equipment, such as a cellular phone, which has various functional restrictions peculiar to the terminal, through use of the provided authoring tool the creator can easily create a content item adapted to the client terminal.

The authoring tool may attach to a content item authentication information for specifying the creator terminal having provided the content item. In this case, the content item may be music data.

Since the user of the creator terminal can attach authentication information to a content item by use of the authoring tool before sending the content item to the distribution server, the distribution server can confirm, in an easy and reliable manner, the creator terminal (creator) having provided the content item, and therefore can properly carry out various procedures, such as a registration procedure, without any difficulty.

According to a third aspect of the present invention, the content item is a piece of music, and the distribution server executes processing in relation to copyright of the content item supplied from the creator terminal to the distribution server. By virtue of this feature, the creator is relieved of the requirement to perform procedures in relation to copyrights, such as a procedure for registering a new piece of music, and a procedure to be performed when an original piece of music is arranged. This is convenient for the creator.

According to a fourth aspect of the present invention, before receiving a content item provided from the creator terminal, the distribution server registers the creator terminal, on the basis of information transmitted from the creator terminal. By virtue of this feature, management of creators can be performed properly at the distribution server, so that processing for accepting content items and kickback processing can be performed without any difficulty.

According to a fifth aspect of the present invention, a content item for examining purpose is transmitted from the creator terminal to the distribution server; and provision of the authoring tool to the creator terminal is permitted only when the content item for examining purpose passes an examination. This feature restricts the number of creators to which the authoring tool is provided, to thereby prevent the number of creators from increasing infinitely.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a schematic diagram of a content distribution system according to the present invention;

FIG. 2 is an illustration showing data stored in the information accumulation section shown in FIG. 1;

FIG. 3 is a chart showing an example procedure for registering a creator;

FIG. 4 is a chart showing an example procedure which the creator follows so as to upload music data to the distribution server;

FIG. 5 is a chart showing an example procedure which a client follows so as to download music data from the distribution server;

FIG. 6 is an illustration showing an example screen which is displayed when the creator uploads music data to the distribution server; and

FIG. 7 is an illustration showing an example music data list which is displayed when the client downloads music data from the distribution server.

### DESCRIPTION OF THE PREFERRED EMBODIMENT

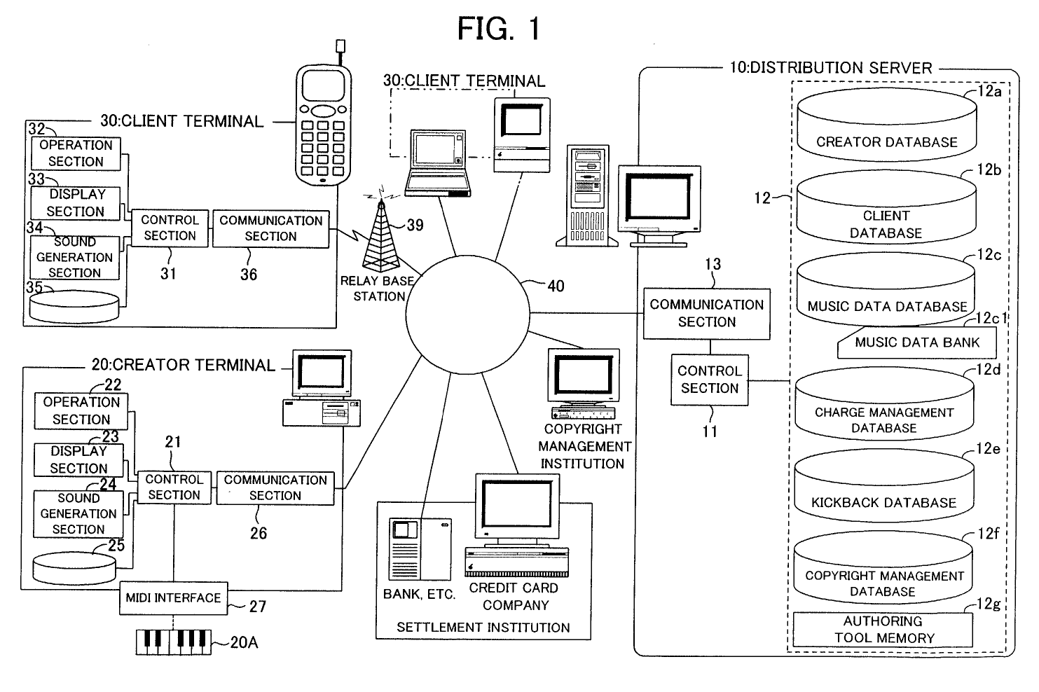

A preferred embodiment of the present invention will be described with reference to the drawings. FIG. 1 is a block diagram of an incoming-call melody distribution system which distributes incoming-call melodies for cellular phones as content items and to which a content distribution system according to the embodiment is applied. The incoming-call melody distribution system includes a distribution server 10, a creator terminal 20 used by a creator, a client terminal 30 used by a client, and the Internet 40 serving as a communication line for mutually connecting the distribution server 10, the creator terminal 20, and the client terminal 30. The creator is a person who provides an incoming-call melody to the distribution server 10. The client is a person who receives the incoming-call melody from the distribution server 10.

The distribution server 10 is constituted by a computer unit so as to accumulate music data of an incoming-call melody (hereinafter simply referred to as music data) supplied from the creator terminal 20 and to distribute the accumulated music data to the client terminal 30 in response to a request from the client terminal 30. The distribution server 10 includes a control section 11, an information accumulation section 12, and a communication section 13. In actuality, operation of the control section 11, communication control operation of the communication section 13, and other operations are realized by program processing. The program is recorded on a recording medium, such as ROM or a hard disk, contained in the computer unit.

The control section 11 is formed of a CPU and other components for executing the above-mentioned program. In response to a signal from the creator terminal 20 or the client terminal 30, the control section 11 accumulates in the information accumulation section 12 information supplied from the creator terminal 20 or the client terminal 30. Further, in response to a signal from the creator terminal 20 or the client terminal 30, the control section 11 supplies to the creator terminal 20 or the client terminal 30 the information accumulated in the information accumulation section 12.

The information accumulation section 12 accumulates various information pieces, which will be described in detail hereinbelow. The information accumulation section 12 includes a creator database 12a, a client database 12b, a music data database 12c, a charge management database 12d, a kickback database 12e, a copyright management database 12f, and authoring tool memory 12g.

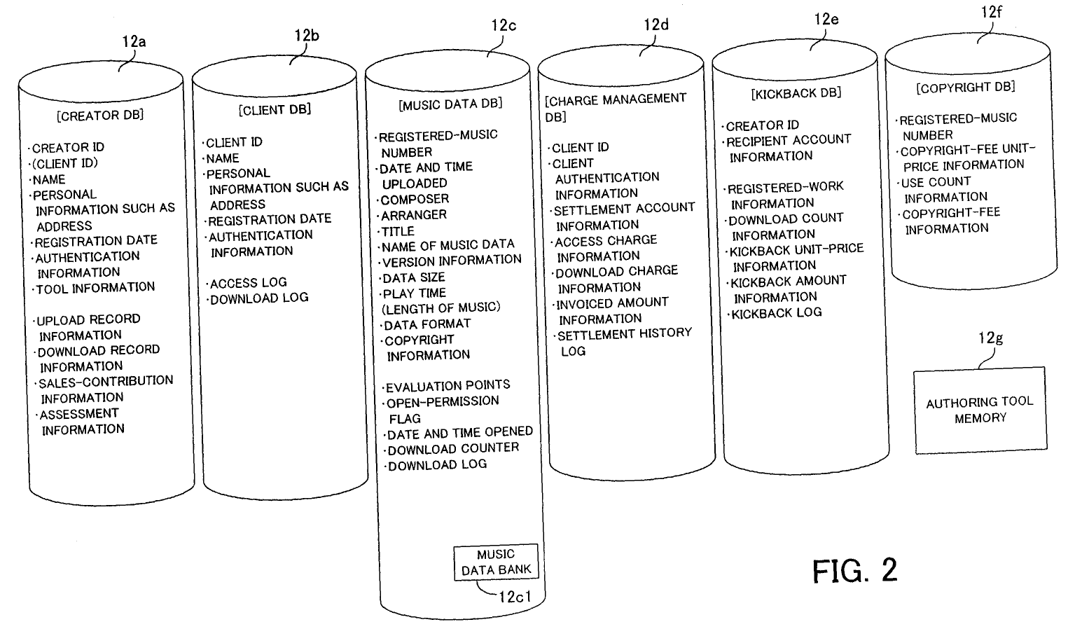

The creator database 12a accumulates information regarding each creator. Specifically, as shown in FIG. 2, the creator database 12a accumulates creator ID, client ID, name, personal information such as address, registration date, authentication information (password, etc.), tool information (identifier (e.g., version, number), etc., of a tool used for creating music), upload record information (registered music, number of opened music pieces, etc.), download record information (number of times of downloading of music data, etc.), sales-contribution information (calculated from the download record, etc.), assessment information (results of an evaluation performed on the basis of the sales-contribution information, etc.), etc..

The client database 12b accumulates information regarding each client. Specifically, as shown in FIG. 2, the client database 12b accumulates client ID, name, personal information such as address, registration date, authentication information (password, etc.), access log (record of accesses to the server), download log (record regarding download of music data, etc.) ,etc.. Notably, an individual may be registered as a client and a creator simultaneously. In this case, the person may be registered in both the creator database 12a and the client database 12b or in one database (e.g., the creator database 12a ) as a client and a creator.

The music data database 12c accumulates information regarding music data provided by the creator. Specifically, as shown in FIG. 2, in addition to music data, the music data database 12c accumulates registered-music number (number allotted to uploaded music), date and time uploaded, composer, arranger, title, name of music data, comments (e.g., explanation regarding music, etc.), version information, data size, play time (length of music), data format (types such as standard MIDI file, incoming-call tone format, etc.), copyright information (license number, etc., if protected by copyright), evaluation points (e.g., results of an evaluation performed by an operator of a server, a person entrusted by the operator, or an ordinary client), an open-permission flag (in which permission for downloading is set manually by the operator of the server or automatically when the evaluation points are equal to or greater than a predetermined value), date and time opened, download counter (number of times of downloading), download log (log of each download),etc.. Further, the music data database 12c has a music data bank 12c1, in which are accumulated music data which are permitted to be opened to the public, through an examination which will be described later.

The charge management database 12d accumulates information used for charging a fee to the client. Specifically, as shown in FIG. 2, the charge management database 12d accumulates client ID, client authentication information, settlement account information (the number of an account used for settlement, the number of a credit card, etc.), access charge information (server connection fee, etc.), download charge information (amount of money charged for downloaded music data), invoiced amount information, settlement history log (past settlement records), etc.

The kickback database 12e accumulates information used for executing kickback to the creator for music data uploaded by the creator. The kickback is performed by using the information when the client downloads the music data uploaded by the client. Specifically, as shown in FIG. 2, the kickback database 12e accumulates creator ID (creator identifier), recipient account number (account number, etc., of the creator), registered-work information (registered-music number), download count information (number of times of downloading for each music piece), kickback unit-price information, kickback amount information (sum total of amounts each calculated through multiplication of the download count by the kickback unit price), kickback log (log of past kickbacks),etc.. The term “kickback” means processing executed by the distribution server 10 for returning to the creator a portion of a profit produced when the client purchases a content item (music data) created by the creator.

The copyright management database 12f accumulates information regarding the copyright of music data provided by the creator. Specifically, as shown in FIG. 2, the copyright management database 12f accumulates registered-music number, copyright-fee unit-price information, use count information, copyright-fee information (amount to be paid to a copyright management institution),etc.

The authoring tool memory 12g stores an authoring tool, which is provided to the creator terminal 20 in response to a request from the creator terminal 20. The authoring tool serves as a converter for converting MIDI data of an SMF (Standard MIDI File) format created on the creator terminal 20 to an incoming-call melody for each of various types of cellular phones, and also serves as an authentication-information attaching tool for attaching to the music data predetermined authentication data for specifying the creator terminal 20, such as an electronic watermark, an electronic signature, or an electronic stamp (such as that disclosed in, for example, Japanese Patent Application Laid-Open No. 11-39796). The cellular phones differ from one another in their hardware and software functions. Therefore, conversion of the MIDI data means conversion of data to be adapted to their functions (e.g., conversion of number of produced sounds, sound tone data, data format, etc.). The creator can upload music data to the distribution server 10 only when he or she uses this tool.

The communication section 13 transmits various data to the communication line 40 and receives various data from the communication line 40 in accordance with a predetermined communication protocol (e.g., HTTP).

The creator terminal 20 is constituted by a computer unit and adapted to supply music data to the distribution server 10. The creator terminal 20 includes a control section 21, an operation section 22, a display section 23, a sound generation section 24, data memory 25, and a communication section 26. In actuality, operation of the control section 21, detection operation of the operation section 22, display control operation of the display section 23, communication control operation of the communication section 26, and other operations are realized by program processing. The program is recorded on a recording medium, such as ROM or a hard disk, contained in the computer unit. Although FIG. 1 shows only one creator terminal 20, in actuality, a large number of creator terminals 20 are connected to the communication line 40.

The control section 21 is formed of a CPU and other components for executing the above-mentioned program and is adapted to receive the authoring tool from the control section 11 of the distribution server 10 and to transmit various data, including music data, to the control section 11 of the distribution server 10. The operation section 22 consists of a mouse and keys corresponding to characters and numerals, etc., and is adapted to supply instruction signals, input data, etc., to the control section 21 in accordance with key operations of the creator. The display section 23 visually displays characters and figures in accordance with instructions from the control section 21. The sound generation section 24 generates sound in accordance with music data. The data memory 25 accumulates music data created by the creator and the authoring tool received from the distribution server 10. The communication section 26 transmits various data to the communication line 40 and receives various data from the communication line 40 in accordance with a predetermined communication protocol (e.g., HTTP).

The creator terminal 20 includes an interface circuit 27 connected to the control section 21. A musical instrument 20A can be connected to the interface circuit 27. The interface circuit 27 enables the control section 21 and the musical instrument 20A to mutually exchange music information (e.g., music data) in a predetermined format (e.g., an MIDI format). The musical instrument 20A is constructed of, for example, an electronic keyboard, a sequencer, etc. The creator uses the music instrument 20A so as to compose or arrange a music piece, which is then supplied to the control section 21 via the interface circuit 27.

The client terminal 30 is a cellular phone capable of receiving music data provided from the distribution server 10. The client terminal 30 includes a computer and is connected to the distribution server 10 via a relay base station 39 and the communication line 40 and through wireless and wired connections. The client terminal 30 includes a control section 31, an operation section 32, a display section 33, a sound generation section 34, data memory 35 and a communication section 36. In actuality, operation of the control section 31, detection operation of the operation section 32, display control operation of the display section 33, communication control operation of the communication section 36 and other operations are realized by program processing. The program is recorded on a recording medium, such as ROM or a hard disk, contained in the computer unit. Although FIG. 1 shows only one client terminal 30, in actuality, a large number of client terminal 30 are connected to the communication line 40.

The control section 31 is formed of a CPU and other components for executing the above-mentioned program and is adapted to receive music data from the control section 11 of the distribution server 10 and to supply data regarding the client to the control section 11 of the distribution server 10. The operation section 32 consists of keys corresponding to characters and numerals, and is adapted to supply instruction signals, input data, etc., to the control section 21 in accordance with key operations of the client. The display section 33 visually displays characters and figures in accordance with instructions from the control section 31. The sound generation section 34 generates sound in accordance with music data received from the distribution server 10. The data memory 35 accumulates music data supplied from the distribution server 10. The communication section 36 transmits various data to the communication line 40 and receives various data from the communication line 40 in accordance with a predetermined communication protocol (e.g., HTTP). The hardware and software functions of the client terminal 30 differ from those of other client terminals of other types. For example, the number of sound-source channels which can produce sounds simultaneously and the number of selectable sound tones vary among client terminals of different types.

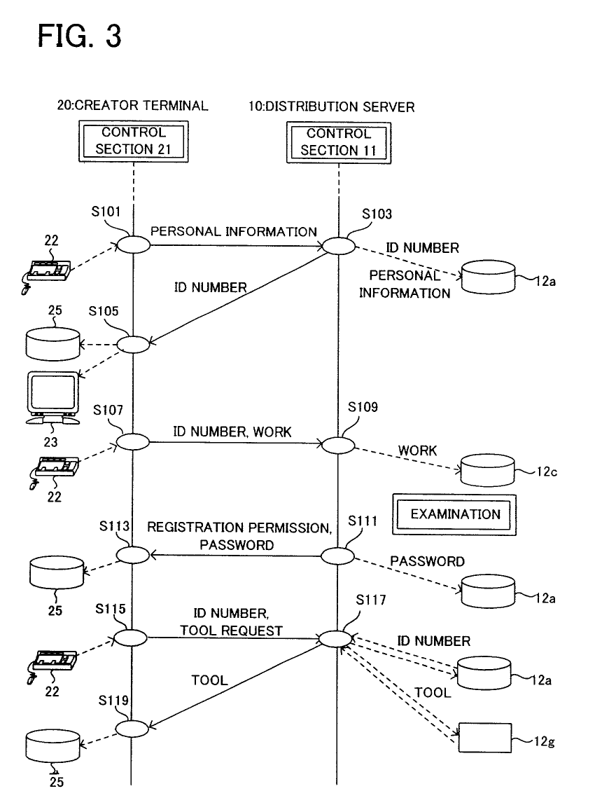

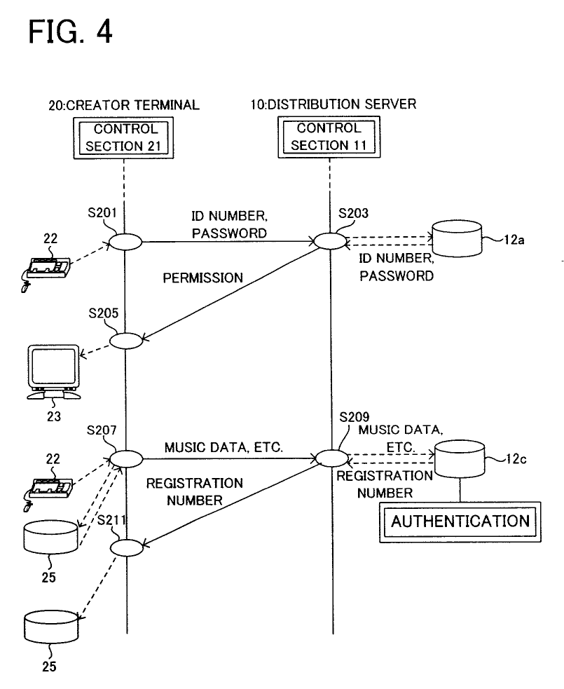

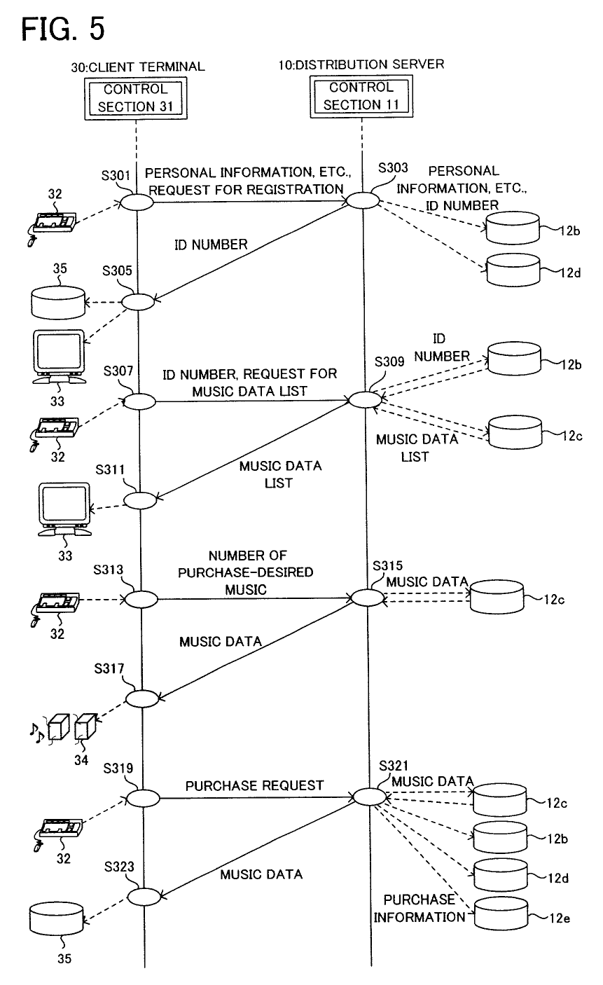

Next, operation of the incoming-call melody distribution system having the above-described configuration will be described with reference to the procedures shown in FIGS. 3 to 5. First, a case where the distribution server 10 provides an authoring tool to the creator terminal 20 will be described.

First, the creator accesses a home page of the distribution server 10 via the communication line 40 and displays a creator application screen on the display section 23. In this state, the creator inputs predetermined personal information (name, E-mail address, etc.) on the creator application screen by operating the operation section 22. In response thereto, the control section 21 transmits the input information to the control section 11 of the distribution server 10 (S101).

In response to the transmission, the control section 11 of the distribution server 10 allots an ID number to the creator on the basis of the transmitted personal information. Subsequently, the control section 11 stores the ID number in the creator database 12a and transmits the ID number to the control section 21 of the creator terminal 20 (S103). In the creator terminal 20, the control section 21 stores the transmitted ID number in the data memory 25 and displays the ID number on the display section 23 (step S105). When the creator inputs an ID number and attaches a work for examining purpose (e.g., content in the SMF (Standard MIDI File) format) by operating the operation section 22, the control section 21 transmits the input information and work to the control section 11 of the distribution server 10 (S107). In this example case, the creator creates in advance a new piece of music (or arranges an existing piece of music) by use of the musical instrument 20A, and stores in the data memory 25 music data representing the created (or arranged) piece of music. The music data stored in the data memory 25 are used as a work (content) for examining purpose.

In response to transmission of the information and the work, the control section 11 of the distribution server 10 stores the transmitted work in the music data database 12c (S109). The level of the transmitted work is examined by the operator of the distribution server 10. When the level of the transmitted work has been judged to be higher than a predetermined level, registration of the creator is permitted. When registration is permitted, the control section 11 of the distribution server 10 allots a password to the creator whose registration has been permitted. Subsequently, the control section 11 registers the password in the creator database 12a and transmits the password to the control section 21 of the creator terminal 20 together with permission for registration(S111). In the creator terminal 20, the control section 21 stores the transmitted password in the data memory 25 (S113). Thus, registration of the creator has been completed, and the creator is not required to transmit a work for examining purpose to the distribution server 10 again. As described above, since registration of the creator is performed under the condition that the level of his/her work is higher than the predetermined level, infinite increase in the number of creators can be avoided.

When, at the creator terminal 20, the creator inputs his/her ID number and a request for an authoring tool by operating the operation section 22, the control section 21 transmits the input information to the control section 11 of the distribution server 10 (S115). In response thereto, the control section 11 of the distribution server 10 compares the transmitted ID number of the creator with the ID number of the creator stored in the creator database 12a . When the two ID numbers coincide with each other, the control section 11 retrieves an authoring tool from the authoring tool memory 12g and transmits the tool to the control section 21 of the creator terminal 20 (S117). That is, the authoring tool is provided to only persons who have passed the examination and who have been registered in the distribution server 10.

In the creator terminal 20, the control section 21 stores the transmitted authoring tool in the data memory 25 (S119). Since any person can obtain the authoring tool and become a creator if he or she passes the examination, a desire of each person to act as a creator and to provide content (music data) created by him/herself to many persons to be used thereby can be satisfied. Notably, the authoring tool may be recorded on a recording medium, such as a CD or MD, and supplied to the creator by means of mailing, parcel delivery, or any other method.

Next, the case where the creator creates music data (e. g., by use of a MIDI tool) and uploads the music data to the distribution server 10 will be described. First, the creator stores in the data memory 25 music data which he/she has created (composed or arranged) by use of the musical instrument 20A. The created music data will be referred to as “main music data.” Subsequently, the creator reads the main music data and the authoring tool from the data memory 25, and, by use of the authoring tool, attaches authentication data to the main music data and coverts the main music data to data suitable for an incoming-call melody for cellular phones of various types. The creator stores in the data memory 25 music data consisting of the converted main music data and the authentication data. Notably, the above-described music data for examining purpose may be used as main music data.

Subsequently, the creator accesses the home page of the distribution server 10 via the communication line 40 and displays a creator confirmation screen on the display section 23. In this state, the creator inputs an ID number and a password on the creator confirmation screen by operating the operation section 22. In response thereto, the control section 21 transmits the input information to the control section 11 of the distribution server 10 (S201).

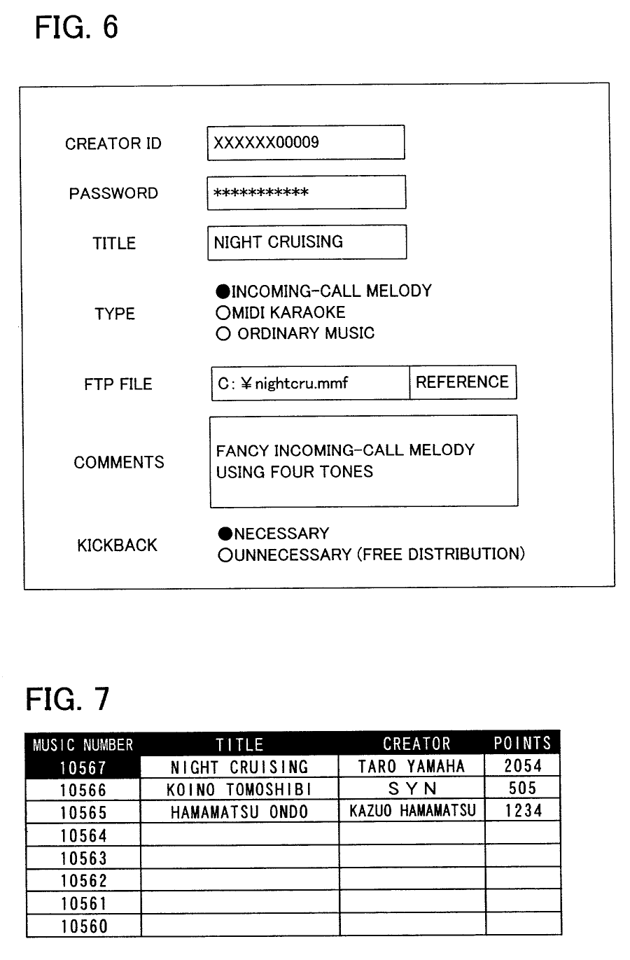

In response to the transmission, the control section 11 of the distribution server 10 compares the transmitted ID number and password of the creator with the ID number and password of the creator stored in the creator database 12a. When the two ID numbers coincide with each other, the control section 11 transmits to the control section 21 of the creator terminal 20 data indicating permission to upload the music data (S203). In response thereto, the control section 21 of the creator terminal 20 displays a work upload screen on the display section 23 (S205). Subsequently, through operation of the operation section 22, the creator inputs the title and type of the piece of music on the work upload screen and designates, as an attachment, the music data stored in the data memory 25. In response to the creator's operation, the control section 21 transmits the data to the control section 11 of the distribution server 10 (S207). FIG. 6 shows an example of the work upload screen.

In response to the transmission, the control section 11 of the distribution server 10 stores the transmitted information and music data in the music data database 12c. Subsequently, the control section 11 checks the authentication data of the music data on the basis of, for example, an electronic watermark or an electronic signature, allots a registration number to the checked music data, and transmits the registration number to the control section 21 of the creator terminal 20 (S209). Since the authentication data are imparted to the music data by means of the authoring tool provided from the distribution server 10 to the creator terminal 20, the distribution server 10 can check the content (music data) from the creator in a simple and reliable manner and therefore can properly perform the above-mentioned registration procedure and kickback processing, which will be described later, without any difficulty. In the creator terminal 20, the control section 21 stores the transmitted registration number in the data memory 25 (S211).

On the distribution server 10 side, the operator checks whether the music data to which the registered number has been allotted contain a data error or any other deficiency and then examines the music data for the degree of completeness, among other conditions. When opening of the music data is permitted as a result of the examination, the music data are transferred to the music data bank 12c1 of the music data database 12c, to thereby be brought into a state in which the music data can be downloaded in response to a request from the client.

If the music data whose opening has been permitted have been obtained through arrangement of an existing music piece, on behalf of the creator, the operator of the distribution server 10 performs a predetermined procedure in coordination with a copyright management institution (e.g., JASRAC (Japanese Society for Rights of Authors, Composers and Publishers) and registers relevant information (e.g., copyright use fee) in the copyright management database 12f. Further, with regard to a new piece of music, the operator of the distribution server 10 performs a simple procedure in coordination with the copyright management institution so as to register the piece of music. This saves effort on the part of the creator and is therefore convenient for the creator.

Next, the case where the client downloads the music data from the distribution server 10 will be described. First, the client accesses the home page of the distribution server 10 via the communication line 40 and displays a client registration screen on the display section 33. In this state, through operation of the operation section 32, the client inputs predetermined personal information (e.g., name, address, account number used for settlement) on the client registration screen, as well as a request for registration. In response thereto, the control section 31 transmits the input information to the control section 11 of the distribution server 10 (S301).

In response to the transmission, the control section 11 of the distribution server 10 allots an ID number to the client on the basis of the transmitted personal information. Subsequently, the control section 11 stores the ID number in the client database 12b and the charge management database 12d and transmits the ID number to the control section 31 of the client terminal 30 (S303). In the client terminal 30,the control section 31 stores the transmitted ID number in the data memory 35 and displays the ID number on the display section 33 (S305). When, through operation of the operation section 32, the client inputs an ID number and a request for provision of a list of music data stored in the music data database 12c of the distribution server 10, the control section 31 transmits the input information to the control section 11 of the distribution server 10 (S307).

In response to transmission of the information, the control section 11 of the distribution server 10 compares the transmitted ID number of the client with the ID number of the client stored in the client database 12b. When the two ID numbers coincide with each other, the control section 11 retrieves a music data list from the music data database 12c and transmits the list to the control section 31 of the client terminal 30 (S309). In the client terminal 30, the control section 31 displays the transmitted music data list on the display section 33 (S311). FIG. 7 shows an example of the screen displayed on the display section 33. Subsequently, through operation of the operation section 32, the client inputs the number of a music piece to be purchased, while viewing the music data list displayed on the display section 33. In response thereto, the control section 31 transmits the input information to the control section 11 of the distribution server 10 (S313).

In response to the transmission, the control section 11 of the distribution server 10 retrieves from the music data database 12c music data corresponding to the transmitted music number and transmits the data to the control section 31 of the client terminal 30 (S315). In the client terminal 30, the control section 31 accumulates the transmitted music data in the data memory 35 and causes the sound generation section 34 to reproduce the music data (S317). Notably, at the present point in time, operation conditions are set such that the music data stored in the data memory 35 are erased when the music data are reproduced a predetermined number of times (e.g.,three times). This enables the client to listen to a piece of music on a trial basis before purchasing it. When, through operation of the operation section 32, the client inputs data indicating that he or she wishes to purchase the music piece listened to on a trial basis, the control section 31 transmits the input information to the control section 11 of the distribution server 10 (S319).

In response thereto, the control section 11 of the distribution server 10 retrieves from the music data database 12c music data requested to purchase by the client terminal 30 and transmits the data to the control section 31 of the client terminal 30. Subsequently, the control section 11 stores purchase information in the client database 12b, the music data database 12c, the charge management database 12d, the kickback database 12e, and the copyright management database 12f (S321), and then performs charge processing and kickback processing, which will be described later. In the client terminal 30, the control section 31 accumulates the transmitted music data in the data memory 35 (S323).

The above-described operation enables the client to use a desired one among content items (music data items) created by many persons (creators). By use of the authoring tool provided from the distribution server 10 to the creator terminal 20, each content item (set of music data) is converted to data suitable for the functions of each of client terminals (cellular phones) 30 of different types. Therefore, the content (music data) can be used by many clients.

Next, the charge processing and kickback processing will be described.

The charge processing which collects a fee for music data from a client who has purchased the music data is performed on the basis of information accumulated in the client database 12b and the charge management database 12d. The charging is performed through adding the purchase price of music data to the call charge of a client terminal (cellular phone) 30 owned by the client. The charging may be performed according to the following schemes. In one scheme, the control section 11 of the distribution server 10 performs necessary data communication with a computer of a bank (settlement institution) at which the client owns an account and automatically withdraws the charged amount from the account. In another scheme, the control section 11 of the distribution server 10 issues an invoice and mails it to the client.

Further, the charging scheme may be a fixed rate scheme or a per-use rate scheme. In the fixed rate scheme, upon payment of a predetermined base fee, the client is allowed to purchase a predetermined number of pieces of music within a predetermined period (e.g., up to 10 pieces of music within one month, upon payment of 300 yen), and the number of purchasable pieces of music remaining is decremented each time the client purchases a piece of music. In the per-use rate scheme, a predetermined amount of money (e.g. 50 yen per piece of music) is charged every time the client purchases a piece of music.

The kickback processing which pays a share to a creator who created downloaded music data is performed on the basis of information accumulated in the kickback database 12e and the copyright management database 12f. The kickback processing is realized through payment of an amount of money which is determined on the basis of the download record and the result of subtracting expenses, such as a server connection fee and communication cost, from an amount of money obtained through charging to the client. The total sum of such kickback payments is obtained at predetermined intervals, such as every month. The payment of kickbacks may be performed such that no kickback is paid when a predetermined number of downloads has not been achieved. Alternatively, there may be employed a system for changing the kickback unit price for single time of download in accordance with the download record. When the downloaded music data are data of a music piece obtained through arrangement of an existing music piece, a copyright use fee paid to the copyright management institution is also deducted. Due to the above-described kickback, the creator comes to create content (music data) enthusiastically, so that a larger number of content items (music data pieces) are accumulated in the distribution server 10.

In the above-described embodiment, the case in which the client terminal 30 is a cellular phone has been described. However, the client terminal is not limited to the cellular phone, and, as shown by an imaginary line in FIG. 1, the client terminal may be a personal computer in which music play/reproduction software is installed.

In the above-described embodiment, the creator application procedure and transmission of content (work) to the distribution server 10 may be performed by use of electronic mails.

In the above-described embodiment, the operator of the distribution server 10 determines whether or not the opening (download) of the music data having an allotted registration number is permitted. However, an examiner appointed by the operator may perform the examination. Alternatively, a creator or client who satisfies predetermined criteria may perform the examination.

The above-described embodiment may be modified in such a manner that the client evaluates the downloaded music piece through voting or marking and transmits the result of evaluation to the distribution server 10. In this case, the distribution server 10 may aggregate the evaluation points for each music data item transmitted from the client, rank each music data item, and reflect the ranking in the kickback unit price of each music piece.

In the above-described embodiment, the case in which content is music data of an incoming-call melody has been described. However, the present invention encompasses distribution of other content items, such as an alarm sound which is produced in a cellular phone serving as the client terminal 30 under predetermined conditions (e.g., an alarm sound generated at a preset time), BGM used during communication by the cellular phone or used with a reply message produced by the automatic answering function of the cellular phone, a music data file attached to an electronic mail mailed to another cellular phone or personal computer, or other music data for MIDI karaoke or ordinary music pieces.

In the above-described embodiment, the Internet 40 is used as a communication line; however, the communication line may be a dedicated line or any of various other communication lines (including a wired line and a wireless line such as a satellite communication line).

Obviously, numerous modifications and variations of the present invention are possible in light of the above teachings. It is therefore to be understood that within the scope of the appended claims, the present invention may be practiced otherwise than as specifically described herein.

What is claimed is:

1. A content distribution system including a creator terminal, a distribution server and a client terminal, and configured such that said creator terminal provides a content item to said distribution server, and said distribution server stores the provided content item and supplies the stored content item to said client terminal in response to a request from said client terminal, wherein said distribution server comprises:
charge processing means for charging a fee to a user of said client terminal when the content item stored in said distribution server is supplied to said client terminal; and
kickback processing means for kicking a portion of the charged fee back to a registered user of said creator terminal who has provided the content item.

2. A content distribution system according to claim 1, wherein
the content item is a piece of music, and
said distribution server further comprises copyright processing means for executing processing in relation to copyright of a content item supplied from said creator terminal to said distribution server.

3. A content distribution system according to claim 1, wherein said distribution server further comprises:
registration means for registering said creator terminal on the basis of information transmitted from said creator terminal before reception of a content item from said creator terminal.

4. A content distribution system according to claim 3, wherein
said transmitted information is a content item for examining purpose, and
said registration means registers said creator terminal depending on results of examination of the content item for examining purpose.

5. A content distribution system according to claim 1, wherein said client terminal is a phone, and said content item is a piece of music used on the phone.

6. A content distribution system including a creator terminal, a distribution server and a client terminal, and configured such that said creator terminal provides a content item to said distribution server, and said distribution server stores the provided content item and supplies the stored content item to said client terminal in response to a request from said client terminal, wherein said distribution server comprises:
tool provision means for providing, in respond to a request from said creator terminal, said creator terminal with an authoring tool for converting into a predetermined format the content item supplied from said creator terminal to said distribution server.

7. A content distribution system according to claim 6, wherein said authoring tool further attaches authentication information for specifying said creator terminal to said converted content item.

8. A content distribution system according to claim 6, wherein
the content item is a piece of music, and
said distribution server further comprises copyright processing means for executing processing in relation to copyright of a content item supplied from said creator terminal to said distribution server.

9. A content distribution system according to claim 6, wherein said distribution server further comprises:
registration means for registering said creator terminal on the basis of information transmitted from said creator terminal before reception of a content item from said creator terminal.

10. A content distribution system according to claim 9, wherein
said transmitted information is a content item for examining purpose, and
said registration means registers said creator terminal depending on results of examination of the content item for examining purpose.

11. A content distribution system according to claim 6, wherein said client terminal is a phone, and said content item is a piece of music used on the phone.

12. A content distribution method which is applied to a content distribution system including a creator terminal, a distribution server and a client terminal, and in which a content item supplied from said creator terminal to said distribution server is stored in said distribution server, and the content item stored in said distribution server is supplied to said client terminal in response to a request from said client terminal, comprising the steps of:
charging a fee to a user of said client terminal when the content item stored in said distribution server is supplied to said client terminal; and
kicking a portion of the charged fee back to a registered user of said creator terminal who has provided the content item.

13. A content distribution method according to claim 12, wherein
the content item is a piece of music, and
said method further comprises the step of causing said distribution server to execute processing in relation to copyright of a content item supplied from said creator terminal to said distribution server.

14. A content distribution method according to claims 12, further comprising step of causing said distribution server to register said creator terminal on the basis of information transmitted from said creator terminal before reception of a content item from said creator terminal.

15. A content distribution method according to claim 14, wherein
said transmitted information is a content item for examining purpose, and
said registration of creator terminal is permitted depending on results of examination of the content item for examining purpose.

16. A content distribution method according to claim 12, wherein
said client terminal is a phone, and said content item is a piece of music used on the phone.

17. A content distribution method which is applied to a content distribution system including a creator terminal, a distribution server and a client terminal, and in which a content item supplied from said creator terminal to said distribution server is stored in said distribution server, and the content item stored in said distribution server is supplied to said client terminal in response to a request from said client terminal, comprising the step of:
causing said distribution server to provide, in respond to a request transmitted from said creator terminal to said distribution server, said creator terminal with an authoring tool for converting into a predetermined format the content item supplied from said creator terminal to said distribution server.

18. A content distribution method according to claim 17, wherein said authoring tool further attaches authentication information for specifying said creator terminal to said converted content item.

19. A content distribution method according to claim 17, wherein
the content item is a piece of music, and
said method further comprises the step of causing said distribution server to execute processing in relation to copyright of a content item supplied from said creator terminal to said distribution server.

20. A content distribution method according to claim 17, further comprising step of causing said distribution server to register said creator terminal on the basis of information transmitted from said creator terminal before reception of a content item from said creator terminal.

21. A content distribution method according to claim 20, wherein
said transmitted information is a content item for examining purpose, and
said registration of creator terminal is permitted depending on results of examination of the content item for examining purpose.

22. A content distribution method according to claim 17, wherein
said client terminal is a phone, and said content item is a piece of music used on the phone.

23. A distribution server which is capable of communicating with a creator terminal and a client terminal and which stores a content item supplied from said creator terminal and distributes the stored content item to said client terminal in response to a request from said client terminal, comprising:
charge processing means for charging a fee to a user of said client terminal when the stored content item is supplied to said client terminal; and
kickback processing means for kicking a portion of the charged fee back to a registered user of said creator terminal who has provided the content item.

24. A distribution server according to claim 23, wherein
the content item is a piece of music, and
said distribution server further comprises copyright processing means for executing processing in relation to copyright of a content item supplied from said creator terminal to said distribution server.

25. A distribution server according to claim 23, wherein said distribution server further comprising:
registration means for registering said creator terminal on the basis of information transmitted from said creator terminal before reception of a content item from said creator terminal.

26. A distribution server according to claim 25, wherein
said transmitted information is a content item for examining purpose, and
said registration means registers said creator terminal depending on results of examination of the content item for examining purpose.

27. A distribution server according to claim 23, wherein said client terminal is a phone, and said content item is a piece of music used on the phone.

28. A distribution server which is capable of communicating with a creator terminal and a client terminal and which stores a content item supplied from said creator terminal and distributes the stored content item to said client terminal in response to a request from said client terminal, comprising:
tool provision means for providing, in respond to a request from said creator terminal, said creator terminal with an authoring tool for converting into a predetermined format the content item supplied from said creator terminal to said distribution server.

29. A distribution server according to claim 28, wherein said authoring tool further attaches authentication information for specifying said creator terminal to said converted content item.

30. A distribution server according to claim 28, wherein
the content item is a piece of music, and
said distribution server further comprises copyright processing means for executing processing in relation to copyright of a content item supplied from said creator terminal to said distribution server.

31. A distribution server according to claim 28, wherein said distribution server further comprising:
registration means for registering said creator terminal on the basis of information transmitted from said creator terminal before reception of a content item from said creator terminal.

32. A distribution server according to claim 31, wherein
said transmitted information is a content item for examining purpose, and
said registration means registers said creator terminal depending on results of examination of the content item for examining purpose.

33. A distribution server according to claim 28, wherein said client terminal is a phone, and said content item is a piece of music used on the phone.

34. A content distribution method applied to a distribution server which is capable of communicating with a creator terminal and a client terminal and which stores a content item supplied from said creator terminal and distributes the stored content item to said client terminal in response to a request from said client terminal, comprising the steps of:
charging a fee to a user of said client terminal when the stored content item is supplied to said client terminal; and
kicking a portion of the charged fee back to a registered user of said creator terminal who has provided the content item.

35. A content distribution method according to claim 34, wherein
the content item is a piece of music, and
said method further comprises the step of executing processing in relation to copyright of a content item supplied from said creator terminal to said distribution server.

36. A content distribution method according to claim 34, further comprising the step of registering said creator terminal on the basis of information transmitted from said creator terminal before reception of a content item from said creator terminal.

37. A content distribution method according to claim 36, wherein
said transmitted information is a content item for examining purpose, and
said registration of creator terminal is permitted depending on results of examination of the content item for examining purpose.

38. A content distribution method according to claim 34, wherein
said client terminal is a phone, and said content item is a piece of music used on the phone.

39. A content distribution method applied to a distribution server which is capable of communicating with a creator terminal and a client terminal and which stores a content item supplied from said creator terminal and distributes the stored content item to said client terminal in response to a request from said client terminal, comprising the step of:
providing, in respond to a request transmitted from said creator terminal, said creator terminal with an authoring tool for converting into a predetermined format the content item supplied from said creator terminal to said distribution server.

40. A content distribution method according to claim 39, wherein said authoring tool further attaches authentication information for specifying said creator terminal to said converted content item.

41. A content distribution method according to claim 39, wherein
the content item is a piece of music, and
said method further comprises the step of executing processing in relation to copyright of a content item supplied from said creator terminal to said distribution server.

42. A content distribution method according to claim 39, further comprising the step of registering said creator terminal on the basis of information transmitted from said creator terminal before reception of a content item from said creator terminal.

43. A content distribution method according to claim 42, wherein
said transmitted information is a content item for examining purpose, and
said registration of creator terminal is permitted depending on results of examination of the content item for examining purpose.

44. A content distribution method according to claim 39, wherein
said client terminal is a phone, and said content item is a piece of music used on the phone.

45. A computer readable recording medium on which is recorded a distribution program applied to a distribution server which is capable of communicating with a creator terminal and a client terminal and which realizes processing for storing a content item supplied from said creator terminal and distributing the stored content item to said client terminal in response to a request from said client terminal, the distribution program executing:
processing for charging a fee to a user of said client terminal when the stored content item is supplied to said client terminal; and
processing for kicking a portion of the charged fee back to a registered user of said creator terminal who has provided the content item.

46. A computer readable recording medium according to claim 45, wherein
the content item is a piece of music, and
said distribution program further executes processing in relation to copyright of a content item supplied from said creator terminal to said distribution server.

47. A computer readable recording medium according to claim 45, wherein said distribution program further executes processing for registering said creator terminal on the basis of information transmitted from said creator terminal before reception of a content item from said creator terminal.

48. A computer readable recording medium according to claim 47, wherein
said transmitted information is a content item for examining purpose, and
said registration of creator terminal is permitted depending on results of examination of the content item for examining purpose.

49. A computer readable recording medium according to claim 45, wherein said client terminal is a phone, and said content item is a piece of music used on the phone.

50. A computer readable recording medium on which is recorded a distribution program applied to a distribution server which is capable of communicating with a creator terminal and a client terminal and which realizes processing for storing a content item supplied from said creator terminal and distributing the stored content item to said client terminal in response to a request from said client terminal, the distribution program executing:
processing for providing, in respond to a request from said creator terminal, said creator terminal with an authoring tool for converting into a predetermined format the content item supplied from said creator terminal to said distribution server.

51. A computer readable recording medium according to claim 50, wherein said authoring tool further attaches authentication information for specifying said creator terminal to said converted content item.

52. A computer readable recording medium according to claim 50, wherein
the content item is a piece of music, and
said distribution program further executes processing in relation to copyright of a content item supplied from said creator terminal to said distribution server.

53. A computer readable recording medium according to claim 50, wherein said distribution program further executes processing for registering said creator terminal on the basis of information transmitted from said creator terminal before reception of a content item from said creator terminal.

54. A computer readable recording medium according to claim 53, wherein
said transmitted information is a content item for examining purpose, and
said registration of creator terminal is permitted depending on results of examination of the content item for examining purpose.

55. A computer readable recording medium according to claim 50, wherein said client terminal is a phone, and said content item is a piece of music used on the phone.
